(19) United States
(12) Patent Application Publication
(10) Pub. No.: US 2007/0203316 A1
(43) Pub. Date: Aug. 30, 2007

(54) FILM-FORMING SILICONE EMULSION COMPOSITION

(75) Inventor: Yoshinori INOKUCHI, Annaka-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 11/671,782

(22) Filed: Feb. 6, 2007

(30) Foreign Application Priority Data
Feb. 27, 2006 (JP) 2006-050499

(51) Int. Cl. C08L 83/04

(52) U.S. Cl. 528/34; 524/838; 524/863; 528/38

(57) ABSTRACT

Zinc compound is added as a curing catalyst to an emulsion composition comprising an organopolysiloxane end-blocked with a hydroxyl or alkoxy group and an aminoalkyl group, both bonded to a silicon atom, an organotrialkoxysilane or tetraalkoxysilane, and a surfactant. The silicone emulsion composition can form a cured film briefly without a need for tin compounds.

### CROSS-REFERENCE TO RELATED APPLICATION

This non-provisional application claims priority under 35 U.S.C. §119(a) on Patent Application No. 2006-050499 filed in Japan on Feb. 27, 2006, the entire contents of which are hereby incorporated by reference.

### TECHNICAL FIELD

This invention relates to a crosslinkable silicone emulsion composition, and more particularly, to a film-forming silicone emulsion composition which forms a cured rubber film through room temperature drying or heat treatment and is useful as a coating composition or precursor thereof.

### BACKGROUND ART

There are known a number of crosslinkable silicone emulsion compositions which form cured rubber films through dehydration.

For example, JP-A 54-131661 discloses an emulsion composition obtained through emulsion polymerization of a cyclic organopolysiloxane and an organotrialkoxysilane. JP-A 56-16553 discloses a hydroxylated diorganopolysiloxane emulsion composition at pH 9-11.5. U.S. Pat. No. 3,355,406 discloses an emulsion composition comprising a hydroxy-containing linear siloxane polymer, a colloid silsesquioxane and optionally, a corsslinker and a catalyst. U.S. Pat. No. 3,706,695 discloses an emulsion composition comprising a hydroxyl-containing diorganopolysiloxane, carbon black, a metal salt of carboxylic acid, and an organotrialkoxysilane. JP-A 58-101153 discloses an emulsion composition comprising a hydroxyl-containing organopolysiloxane, the reaction product of an amino-functional silane and an acid anhydride, colloidal silica, and a curing catalyst. JP-A 8-85760 discloses an emulsion composition comprising an alkoxy or hydroxyl-containing linear organopolysiloxane, an Si—H bond-bearing organopolysiloxane, silica or polysilsesquioxane, an amide and carboxyl-containing organoalkoxysilane, an epoxy or amino-containing organoalkoxysilane, and a curing catalyst. JP-A 11-158380 discloses an emulsion composition comprising a hydroxyl or alkoxy end-capped branched organopolysiloxane, an organopolysiloxane having two or three hydroxyl or alkoxy groups bonded to a silicon atom, powdered silica and a curing promoter. JP-A 56-501488 discloses an emulsion composition comprising a hydroxyl end-blocked polydiorganosiloxane containing vinyl-substituted siloxane units, which is modified such that crosslinking takes place by forming radicals within the siloxane. JP-A 7-196984 discloses an emulsion composition comprising an amino-containing organopolysiloxane and an epoxy-containing hydrolyzable silane or an emulsion composition comprising an epoxy-containing organopolysiloxane and an amino-containing hydrolyzable silane. These emulsion compositions cure through dehydration by drying at room temperature or by heating. In order to form fully cured films within a short time, tin compounds having high catalysis must be used. However, the current industry avoids the use of tin compounds due to their toxicity.

Besides, JP-A 7-150045 and JP-A 8-188715 disclose an emulsion composition comprising an alkoxysilyl end-blocked diorganopolysiloxane and a titanium catalyst. Such a formulation involving preparing an organosiloxane emulsion and adding a titanium catalyst thereto offers a high curing rate, but is undesirably inconsistent in reactivity because the titanium catalyst can be deactivated upon contact with water.

Further, JP-A 56-36546 discloses an emulsion composition comprising a vinyl end-capped diorganopolysiloxane, an organosilicon compound having silicon-bonded hydrogen atoms, and a platinum catalyst. This composition has a high curing rate, but ceases to cure when contacted with contaminants containing amine, tin, phosphorus, sulfur or the like.

### DISCLOSURE OF THE INVENTION

An object of the invention is to provide a silicone emulsion composition which can form a cured film briefly without a need for tin compounds.

To attain the above object, the inventor previously proposed in JP-A 2005-306994 an emulsion composition comprising an organopolysiloxane end-blocked with a hydroxyl or alkoxy group and an aminoalkyl group, both bonded to a silicon atom, and an organotrialkoxysilane or tetraalkoxysilane. This composition cures in the presence of a catalyst selected from among sodium, aluminum, potassium, calcium, vanadium, iron, cobalt, nickel, zirconium, and barium compounds. However, the cure rate tends to lower as the organopolysiloxane increases its degree of polymerization. The composition is not satisfactory in fast cure as required when used during the fabrication of articles.

Continuing further research, the inventor has found that when a specific amount of zinc compound is added as a curing catalyst to an emulsion composition comprising an organopolysiloxane end-blocked with a hydroxyl or alkoxy group and an aminoalkyl group, both bonded to a silicon atom, and an organotrialkoxysilane or tetraalkoxysilane, the resulting silicone emulsion composition can form a cured film briefly without a need for tin compounds.

Accordingly, the present invention provides a film-forming silicone emulsion composition comprising (A) a diorganopolysiloxane having the general formula (1):

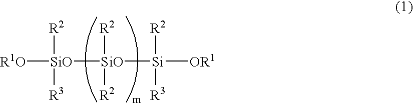

wherein R¹ is each independently hydrogen or a monovalent hydrocarbon group of 1 to 6 carbon atoms, R² is each independently a monovalent hydrocarbon group of 1 to 20 carbon atoms, R³ is a group of the general formula (2):

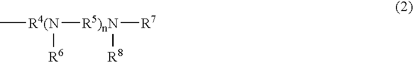

wherein R⁴ is a substituted or unsubstituted divalent hydrocarbon group of 1 to 6 carbon atoms, R⁵ is a divalent hydrocarbon group of 1 to 4 carbon atoms, R⁶, R⁷ and R⁸ are each independently hydrogen or a substituted or unsubstituted monovalent hydrocarbon group of 1 to 10 carbon atoms, n is an integer of 0 to 6, with the proviso that at least one of R⁶, R⁷ and R⁸ is hydrogen when n is not equal to 0 and at least one of R⁷ and R⁸ is hydrogen when n is equal to 0, and m is an integer from 200 to 2,000,

(B) an alkoxysilane having the general formula (3):

R⁹ₐSi(OR¹⁰)₄₋ₐ (3)

wherein R⁹ is a substituted or unsubstituted monovalent hydrocarbon group of 1 to 20 carbon atoms, R¹⁰ is each independently a monovalent hydrocarbon group of 1 to 6 carbon atoms, and “a” is equal to 0 or 1, and/or a partial hydrolytic condensate thereof,

(C) 0.01 to 5 parts by weight per 100 parts by weight of components (A) and (B) combined of a zinc compound, and

(D) 0.1 to 30 parts by weight per 100 parts by weight of components (A) and (B) combined of a surfactant.

### BENEFITS OF THE INVENTION

The crosslinkable silicone emulsion composition of the invention forms a cured rubber film through room temperature drying or heat treatment. Especially heating completes curing within a very short time. The composition is useful as a coating composition or precursor thereof.

### DESCRIPTION OF THE PREFERRED EMBODIMENT

Component (A) is a diorganopolysiloxane end-blocked with a hydroxyl or alkoxy group and an aminoalkyl group, both bonded to a silicon atom, represented by the general formula (1).

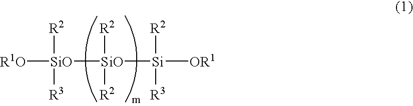

In formula (1), R¹ is each independently a hydrogen atom or a monovalent hydrocarbon group of 1 to 6 carbon atoms. Examples of monovalent hydrocarbon groups include alkyl groups such as methyl, ethyl, propyl, isopropyl, butyl, tert-butyl, pentyl, and hexyl, with methyl being most preferred.

R² is each independently a monovalent hydrocarbon group of 1 to 20 carbon atoms. Examples include alkyl groups such as methyl, ethyl, propyl, isopropyl, butyl, tert-butyl, pentyl, hexyl, octyl, decyl, dodecyl, tetradecyl, hexadecyl, octadecyl, and eicosyl; cycloalkyl groups such as cyclopentyl and cyclohexyl; alkenyl groups such as vinyl and allyl; aryl groups such as phenyl and tolyl; aralkyl groups such as benzyl and 2-phenylethyl; and substituted forms of the foregoing hydrocarbon groups in which some or all hydrogen atoms are substituted by fluorine, chlorine or bromine atoms, such as halogenated alkyl groups, e.g., 3,3,3-trifluoropropyl and 3-chloropropyl. It is preferred from the industrial aspect and for imparting mold release properties that at least 90 mol % of R² groups be methyl.

R³ is an aminoalkyl group of the general formula (2).

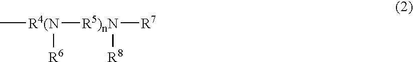

In formula (2), R⁴ is a substituted or unsubstituted divalent hydrocarbon group of 1 to 6 carbon atoms, examples of which include alkylene groups such as methylene, ethylene, trimethylene, tetramethylene, pentamethylene, and hexamethylene, arylene groups such as p-phenylene, and substituted forms of the foregoing hydrocarbon groups in which some or all hydrogen atoms are substituted by fluorine, chlorine or bromine atoms, such as 1-chlorotrimethylene, with trimethylene being most preferred.

R⁵ is a divalent hydrocarbon group of 1 to 4 carbon atoms, examples of which include alkylene groups such as methylene, ethylene, trimethylene, and tetramethylene, with ethylene being most preferred.

Each of R⁶, R⁷ and R⁸, which may be the same or different, is a hydrogen atom or a substituted or unsubstituted monovalent hydrocarbon group of 1 to 10 carbon atoms. Examples include hydrogen; alkyl groups such as methyl, ethyl, propyl, isopropyl, butyl, tert-butyl, pentyl, hexyl, octyl, and decyl; cycloalkyl groups such as cyclopentyl and cyclohexyl; alkenyl groups such as vinyl and allyl; aryl groups such as phenyl and tolyl; aralkyl groups such as benzyl and 2-phenylethyl; and substituted forms of the foregoing hydrocarbon groups in which some or all hydrogen atoms are substituted by fluorine, chlorine or bromine atoms, such as halogenated alkyl groups, e.g., 3,3,3-rifluoropropyl and 3-chloropropyl. Of these, hydrogen and methyl are preferred.

The subscript n is an integer of 0 to 6, with the proviso that at least one of R⁶, R⁷ and R⁸ is hydrogen when n is not equal to 0, and at least one of R⁷ and R⁸ is hydrogen when n is equal to 0.

Exemplary preferred aminoalkyl groups of formula (2) include, but are not limited to, —C₃H₆NH₂, —C₃H₆NHC₂H₄NH₂, —₃H₆(NHC₂H₄)₂NH₂, —C₃H₆ (NHC₂H₄)₃NH₂, —C₃H₆NHCH₃, and —₃H₆NHC₂H₄NHCH₃.

In formula (1), m is an integer from 200 to 2,000. Notably, the emulsion composition of the invention is intended to form a flexible silicone film. If m is less than 200, the resulting film becomes hard. If m is more than 2,000, the organopolysiloxane has so high a viscosity that it cannot be finely dispersed in an emulsifying dispersion system to be described later, making it difficult to provide an emulsion having satisfactory shelf stability.

The method of preparing the diorganopolysiloxane of formula (1) is not particularly limited. One typical method is alcohol-removing condensation reaction of α,ω-dihydroxy-dimethylpolysiloxane with a dialkoxysilane compound having a silicon-bonded alkylamino group.

It is acceptable in the practice of the invention to react the diorganopolysiloxane of formula (1) with an organic acid. The organic acid reacts with the aminoalkyl group in the organopolysiloxane to form an amine salt (i.e., ion pair) for thereby rendering the organopolysiloxane of formula (1) hydrophilic. It is then expectable that the organopolysiloxane is more finely dispersed in an aqueous medium.

The organic acid used herein is not particularly limited as long as it can form the amine salt. Suitable organic acids include aliphatic carboxylic acids of 1 to 6 carbon atoms such as formic acid, acetic acid, propionic acid, malonic acid, and citric acid; sulfonic acids of 1 to 6 carbon atoms such as methanesulfonic acid and ethanesulfonic acid; and sulfinic acids of 1 to 6 carbon atoms such as ethanesulfinic acid. Inter alia, formic acid and acetic acid are most preferred. The organic acids may be used alone or in combination of two or more. An appropriate amount of the organic acid is equal to or less than 1 molar equivalent relative to the amino moiety of the aminoalkyl group.

Component (B) is an alkoxysilane having the general formula (3) and/or a partial hydrolytic condensate thereof.

R⁹ₐSi(OR¹⁰)₄₋ₐ (3)

Herein R⁹ is a substituted or unsubstituted monovalent hydrocarbon group of 1 to 20 carbon atoms. Examples include alkyl groups such as methyl, ethyl, propyl, isopropyl, butyl, tert-butyl, pentyl, hexyl, octyl, decyl, dodecyl, tetradecyl, hexadecyl, octadecyl, and eicosyl; cycloalkyl groups such as cyclopentyl and cyclohexyl; alkenyl groups such as vinyl and allyl; aryl groups such as phenyl and tolyl; aralkyl groups such as benzyl and 2-phenylethyl; and substituted forms of the foregoing hydrocarbon groups in which some or all hydrogen atoms are substituted by halogen atoms (e.g., fluoro, chloro or bromo) or functional groups containing amino or the like, such as halogenated alkyl groups, e.g., 3,3,3-trifluoropropyl and 3-chloropropyl, and aminoalkyl groups, e.g., N-(β-aminoethyl)-γ-aminopropyl and γ-aminopropyl. Of these, methyl, phenyl, vinyl and 3,3,3-trifluoropropyl are preferred.

R¹⁰ is each independently a monovalent hydrocarbon group of 1 to 6 carbon atoms. Examples of monovalent hydrocarbon groups include alkyl groups such as methyl, ethyl, propyl, isopropyl, butyl, tert-butyl, pentyl, and hexyl, with methyl and ethyl being most preferred.

The subscript “a” is equal to 0 or 1.

Suitable alkoxysilanes of formula (3) are those wherein “a” is 1, including methyltrimethoxysilane, methyltriethoxysilane, methyltripropoxysilane, methyltributoxysilane, ethyltrimethoxysilane, ethyltriethoxysilane, propyltrimethoxysilane, propyltriethoxysilane, butyltrimethoxysilane, pentyltrimethoxysilane, hexyltrimethoxysilane, octyltrimethoxysilane, decyltrimethoxysilane, dodecyltrimethoxysilane, tetradecyltrimethoxysilane, octadecyltrimethoxysilane, vinyltrimethoxysilane, vinyltriethoxysilane, phenyltrimethoxysilane, phenyltriethoxysilane, 3,3,3-trifluoropropyltrimethoxysilane, and 3,3,3-trifluoropropyltriethoxysilane; and those wherein “a” is 0, including tetramethoxysilane, tetraethoxysilane, tetrapropoxysilane, and tetrabutoxysilane. Of these, preference is given to methyltrimethoxysilane, methyltriethoxysilane, phenyltrimethoxysilane, phenyltriethoxysilane, vinyltrimethoxysilane, vinyltriethoxysilane, 3,3,3-trifluoropropyltrimethoxysilane, 3,3,3-trifluoropropyltriethoxysilane, tetramethoxysilane, and tetraethoxysilane.

As component (B), either the alkoxysilanes mentioned above or partial hydrolytic condensates thereof may be used. They may be used alone or in combination of two or more.

Component (B) is a crosslinker for component (A), allowing condensation reaction to form a cured silicone elastomer. This condensation reaction is the condensation reaction of hydroxyl and/or R¹O— groups in component (A) with R¹⁰O— groups in component (B) and may include to some extent the condensation reaction between R¹⁰O— groups in component (B).

An amount of component (B) used relative to component (A) is often such that 0.5 to 100 moles, preferably 1.0 to 50 moles of R¹⁰O— groups in component (B) are available per mole of total hydroxyl and R¹O— groups in component (A). If the amount of component (B) used is too small, the condensation curing reaction may become insufficient to form an elastomer. If the amount of component (B) used is too large, the condensation reaction between R¹⁰O— groups in component (B) may become prominent, resulting in a cured product with a high hardness or poor elasticity and increasing the amount of alcohol by-products.

Component (C) is a zinc compound which is a catalyst for promoting the above-described condensation reaction. Suitable zinc compounds include, but are not limited to, zinc carboxylates such as zinc 2-ethylhexanoate, zinc neodecanoate, zinc oleate, and zinc naphthenate; organic zinc complexes such as acetylacetonatozinc and ethylacetoacetonatozinc; zinc salts such as zinc chloride, zinc sulfate, zinc nitrate, zinc phosphate, and zinc carbonate; and zinc hydroxide. They may be used alone or in combination of two or more.

Component (C) is used in an effective or catalytic amount, specifically 0.01 to 5 parts by weight, preferably 0.1 to 2 parts by weight per 100 parts by weight of components (A) and (B) combined. If the amount of component (C) is too small, condensation reaction does not proceed, failing to form a cured film. Too large amounts of component (C) achieve little further effect and are uneconomical.

Component (D) is a surfactant which is an emulsifier for emulsifying and dispersing components (A), (B) and (C) in water.

Illustrative, non-limiting examples of the surfactant (D) include
nonionic surfactants such as polyoxyethylene alkyl ethers, polyoxyethylene polyoxypropylene alkyl ethers, polyoxyethylene alkyl phenyl ethers, polyethylene glycol fatty acid esters, sorbitan fatty acid esters, polyoxyethylene sorbitan fatty acid esters, polyoxyethylene sorbitol fatty acid esters, glycerin fatty acid esters, polyoxyethylene glycerin fatty acid esters, polyglycerin fatty acid esters, propylene glycol fatty acid esters, polyoxyethylene castor oil, polyoxyethylene hardened castor oil, polyoxyethylene hardened castor oil fatty acid esters, polyoxyethylene alkyl amines, polyoxyethylene fatty acid amides, polyoxyethylene-modified organopolysiloxanes, polyoxyethylene polyoxypropylene-modified organopolysiloxanes;
anionic surfactants such as alkyl hydrogensulfate, polyoxyethylene alkyl ether hydrogensulfate, polyoxyethylene alkyl phenyl ether hydrogensulfate, N-acyltaurine, alkylbenzenesulfonates, polyoxyethylene alkyl phenyl ether sulfonates, α-olefin sulfonates, alkylnaphthalene sulfonates, alkyl diphenyl ether disulfonates, dialkylsulfosuccinates, monoalkylsulfosuccinates, polyoxyethylene alkyl ether sulfosuccinates, fatty acid salts, polyoxyethylene alkyl ether acetates, N-acylamino acid salts, alkenylsuccinates, alkyl phosphates, polyoxyethylene alkyl ether phosphates, polystyrene sulfonates, naphthalene sulfonic acid-formalin condensates, aromatic sulfonic acid-formalin condensates, polymeric carboxylic acids, and styrene-oxyalkylene-acid anhydride copolymers;
cationic surfactants such as alkyltrimethylammonium salts, dialkyldimethylammonium salts, polyoxyethylene alkyldimethylammonium salts, dipolyoxyethylene alkylmethylammonium salts, tripolyoxyethylene alkylammonium salts, alkylbenzyldimethylammonium salts, alkylpyridinium salts, monoalkylamine salts, and monoalkylamide amine salts; and
ampholytic surfactants such as alkyl dimethylamine oxides, alkyl dimethylcarboxybetains, alkylamide propyl dimethylcarboxybetains, alkyl hydroxysulfobetains, and alkylcarboxymethyl hydroxyethyl imidazolinium betains. These surfactants may be used alone or in combination of two or more although combinations of anionic surfactants with cationic surfactants are excluded.

Component (D) is used in an amount of 0.1 to 30 parts by weight, preferably 1 to 20 parts by weight per 100 parts by weight of components (A) and (B) combined. If the amount of component (D) is too small, the composition fails in emulsifying dispersion and has poor shelf stability. If the amount of component (D) is too large, the resulting film becomes brittle and poor in water resistance.

The film-forming silicone emulsion composition of the invention may be prepared by emulsifying and dispersing a mixture of diorganopolysiloxane (A), alkoxysilane (B) and zinc compound (C) in water in the presence of surfactant (D). In the event curing reaction proceeds prior to formation of an emulsified dispersion liquid and thus interferes with the emulsifying dispersion process, the method may be modified such that component (A) is first emulsified and dispersed in water with the aid of component (D), and components (B) and (C) are added thereto, followed by agitation; a mixture of components (A) and (B) is first emulsified and dispersed in water with the aid of component (D), and component (C) is added thereto, followed by agitation; or a mixture of components (A) and (C) is first emulsified and dispersed in water with the aid of component (D), and component (B) is added thereto, followed by agitation.

When component (C) is added to an emulsified dispersion liquid of component (A) or components (A) and (B), component (C) may be previously dissolved in the surfactant or emulsified and dispersed in an aqueous surfactant solution to facilitate the dispersion of component (C). When component (C) is water soluble, the method involving emulsifying and dispersing component (A) or components (A) and (B) in water and then adding component (C) or the method involving dissolving component (C) in water and emulsifying and dispersing component (A) or components (A) and (B) in that water may be employed.

Emulsifying dispersion may be performed using agitating devices such as homomixers and dispersion mixers or emulsifying devices such as high-pressure homogenizers and colloid mills.

In the emulsified dispersion liquid, the amount of components (A) and (B) combined may preferably be about 5 to 80% by weight, more preferably about 10 to 60% by weight. Too lower concentrations of components (A) and (B) are uneconomical. Too higher concentrations mean that the emulsified dispersion liquid may have too high a viscosity and be difficult to handle.

The film-forming silicone emulsion composition of the invention is coated to substrates of various materials and dried at room temperature or heat treated, forming a cured film having rubber elasticity. Film properties may be further improved by adding another aqueous material or powder to the emulsion composition. In coating the silicone emulsion composition to substrates, any of well-known coating techniques may be employed in accordance with the type of substrate. Where the coating is heat treated, appropriate heating is at 50 to 300° C. for about 1 to about 60 minutes.

The film-forming silicone emulsion composition of the invention finds use in a variety of applications, for example, mar-protective agents, water-repellents and parting agents for paper, plastic sheets and rubber articles; mar-protective agents, water-repellents, waterproof agents, drape improvers and sealing compounds for fabric; water-repellents, waterproof agents and parting agents for concrete, mortar, and wood. In an extended application, the emulsion composition may be added to or compounded in aqueous paint, ink or coating compositions for improving coat properties.

### EXAMPLE

Examples of the invention are given below by way of illustration and not by way of limitation. In Examples, all percents are by weight. The viscosity is measured at 25° C. according to the method of JIS K2283. An aliquot weighs a few grams.

### Example 1

A 1000-ml glass beaker was charged with 400 g of an organopolysiloxane of formula (4) having a viscosity of 112,000 mm²/s and 17 g of vinyltrimethoxysilane, which were agitated by a homomixer for 5 minutes. Then, 20 g of polyoxyethylene decyl ether (moles of ethylene oxide added=4), 20 g of polyoxyethylene decyl ether (moles of ethylene oxide added=40), and 36 g of water were added. The mixture was agitated by the homomixer, during which a buildup of viscosity was observed. Using a dispersion mixer, it was milled and agitated for a further 10 minutes. Water, 295 g, was added to the mixture and agitated for dilution by the homomixer. With agitation using an anchor-type paddle, a mixture of 6 g of a mineral spirit solution of 44% zinc 2-ethylhexanoate and 6 g of polyoxyethylene decyl ether (moles of ethylene oxide added=8) was then added. Agitation for one hour yielded a silicone emulsion.

After 48 hours from its preparation, an aliquot from the silicone emulsion was placed in a dish where it was allowed to stand at room temperature for 24 hours, during which time water volatilized off, leaving a solid matter. This cured product was found tack-free and elastic on finger touch. Separately, the silicone emulsion was brush coated onto a rubber sheet and heat treated at 150° C. for 1 minute. The coated surface was found to be a cured film which was tack-fee on finger touch.

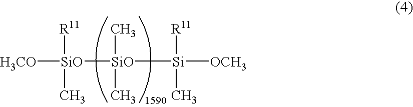

R¹¹ is a group of —C₃H₆NHC₂H₄NH₂.

### Example 2

A 1000-ml glass beaker was charged with 400 g of the organopolysiloxane of formula (4) having a viscosity of 112,000 mm²/s and 15 g of methyltrimethoxysilane, which were agitated by a homomixer for 5 minutes. Then, 20 g of polyoxyethylene decyl ether (moles of ethylene oxide added=4), 20 g of polyoxyethylene decyl ether (moles of ethylene oxide added=40), and 36 g of water were added. The mixture was agitated by the homomixer, during which a buildup of viscosity was observed. Using a dispersion mixer, it was milled and agitated for a further 10 minutes. Water, 297 g, was added to the mixture and agitated for dilution by the homomixer. With agitation using an anchor-type paddle, a mixture of 6 g of a mineral spirit solution of 44% zinc 2-ethylhexanoate and 6 g of polyoxyethylene decyl ether (moles of ethylene oxide added=8) was then added. Agitation for one hour yielded a silicone emulsion.

After 48 hours from its preparation, an aliquot from the silicone emulsion was placed in a dish where it was allowed to stand at room temperature for 24 hours, during which time water volatilized off, leaving a solid matter. This cured product was found tack-free and elastic on finger touch. Separately, the silicone emulsion was brush coated onto a rubber sheet and heat treated at 150° C. for 1 minute. The coated surface was found to be a cured film which was tack-fee on finger touch.

### Example 3

A 1000-ml glass beaker was charged with 400 g of the organopolysiloxane of formula (4) having a viscosity of 112,000 mm²/s and 18 g of tetramethoxysilane, which were agitated by a homomixer for 5 minutes. Then, 20 g of polyoxyethylene decyl ether (moles of ethylene oxide added=4), 20 g of polyoxyethylene decyl ether (moles of ethylene oxide added=40), and 36 g of water were added. The mixture was agitated by the homomixer, during which a buildup of viscosity was observed. Using a dispersion mixer, it was milled and agitated for a further 10 minutes. Water, 294 g, was added to the mixture and agitated for dilution by the homomixer. With agitation using an anchor-type paddle, a mixture of 6 g of a mineral spirit solution of 44% zinc 2-ethylhexanoate and 6 g of polyoxyethylene decyl ether (moles of ethylene oxide added=8) was then added. Agitation for one hour yielded a silicone emulsion.

After 48 hours from its preparation, an aliquot from the silicone emulsion was placed in a dish where it was allowed to stand at room temperature for 24 hours, during which time water volatilized off, leaving a solid matter. This cured product was found tack-free and elastic on finger touch. Separately, the silicone emulsion was brush coated onto a rubber sheet and heat treated at 150° C. for 1 minute. The coated surface was found to be a cured film which was tack-fee on finger touch.

### Example 4

A 1000-ml glass beaker was charged with 400 g of the organopolysiloxane of formula (4) having a viscosity of 112,000 mm²/s and 6 g of a mineral spirit solution of 44% zinc 2-ethylhexanoate, which were agitated by a homomixer for 5 minutes. Then, 20 g of polyoxyethylene decyl ether (moles of ethylene oxide added=4), 20 g of polyoxyethylene decyl ether (moles of ethylene oxide added=40), and 36 g of water were added. The mixture was agitated by the homomixer, during which a buildup of viscosity was observed. Using a dispersion mixer, it was milled and agitated for a further 10 minutes. Water, 291 g, was added to the mixture and agitated for dilution by the homomixer. With agitation using an anchor-type paddle, 27 g of phenyltriethoxysilane was then added. Agitation for one hour yielded a silicone emulsion.

After 48 hours from its preparation, an aliquot from the silicone emulsion was placed in a dish where it was allowed to stand at room temperature for 24 hours, during which time water volatilized off, leaving a solid matter. This cured product was found tack-free and elastic on finger touch. Separately, the silicone emulsion was brush coated onto a rubber sheet and heat treated at 150° C. for 1 minute. The coated surface was found to be a cured film which was tack-fee on finger touch.

### Example 5

A 1000-ml glass beaker was charged with 400 g of the organopolysiloxane of formula (4) having a viscosity of 112,000 mm²/s and 6 g of a mineral spirit solution of 44% zinc 2-ethylhexanoate, which were agitated by a homomixer for 5 minutes. Then, 20 g of polyoxyethylene decyl ether (moles of ethylene oxide added=4), 20 g of polyoxyethylene decyl ether (moles of ethylene oxide added=40), and 36 g of water were added. The mixture was agitated by the homomixer, during which a buildup of viscosity was observed. Using a dispersion mixer, it was milled and agitated for a further 10 minutes. Water, 293 g, was added to the mixture and agitated for dilution by the homomixer. With agitation using an anchor-type paddle, 25 g of 3,3,3-trifluoropropyltrimethoxysilane was then added. Agitation for one hour yielded a silicone emulsion.

After 48 hours from its preparation, an aliquot from the silicone emulsion was placed in a dish where it was allowed to stand at room temperature for 24 hours, during which time water volatilized off, leaving a solid matter. This cured product was found tack-free and elastic on finger touch. Separately, the silicone emulsion was brush coated onto a rubber sheet and heat treated at 150° C. for 1 minute. The coated surface was found to be a cured film which was tack-fee on finger touch.

### Example 6

A 1000-ml glass beaker was charged with 400 g of an organopolysiloxane of formula (5) having a viscosity of 11,400 mm²/s, 20 g of polyoxyethylene decyl ether (moles of ethylene oxide added=4), 20 g of polyoxyethylene decyl ether (moles of ethylene oxide added=40), and 32 g of water, which were agitated by a homomixer, during which a buildup of viscosity was observed. Using a dispersion mixer, it was milled and agitated for a further 10 minutes. Water, 296 g, was added to the mixture, which was agitated for dilution by the homomixer. With agitation using an anchor-type paddle, 20 g of vinyltriethoxysilane was then added and agitated for one hour. Further a mixture of 6 g of a mineral spirit solution of 44% zinc 2-ethylhexanoate and 6 g of polyoxyethylene decyl ether (moles of ethylene oxide added=8) was added and agitated for one minute, yielding a silicone emulsion.

After 48 hours from its preparation, an aliquot from the silicone emulsion was placed in a dish where it was allowed to stand at room temperature for 24 hours, during which time water volatilized off, leaving a solid matter. This cured product was found tack-free and elastic on finger touch. Separately, the silicone emulsion was brush coated onto a rubber sheet and heat treated at 150° C. for 1 minute. The coated surface was found to be a cured film which was tack-fee on finger touch.

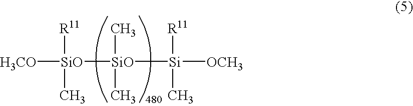

R¹¹ is a group of —C₃H₆NHC₂H₄NH₂.

### Comparative Example 1

A 1000-ml glass beaker was charged with 400 g of an organopolysiloxane of formula (6) having a viscosity of 104,000 mm²/s and 17 g of vinyltrimethoxysilane, which were agitated by a homomixer for 5 minutes. Then, 20 g of polyoxyethylene decyl ether (moles of ethylene oxide added=4), 20 g of polyoxyethylene decyl ether (moles of ethylene oxide added=40), and 36 g of water were added. The mixture was agitated by the homomixer, during which a buildup of viscosity was observed. Using a dispersion mixer, it was milled and agitated for a further 10 minutes. Water, 295 g, was added to the mixture and agitated for dilution by the homomixer. With agitation using an anchor-type paddle, a mixture of 6 g of a mineral spirit solution of 44% zinc 2-ethylhexanoate and 6 g of polyoxyethylene decyl ether (moles of ethylene oxide added=8) was then added. Agitation for one hour yielded a silicone emulsion.

After 48 hours from its preparation, an aliquot from the silicone emulsion was placed in a dish where it was allowed to stand at room temperature for 24 hours, during which time water volatilized off. The residue was liquid, indicating that the silicone had not cured. Separately, the silicone emulsion was brush coated onto a rubber sheet and heat treated at 150° C. for 1 minute. A finger touch test on the coated surface showed that the silicone had not cured.

This example demonstrates that an emulsion is little curable when an organopolysiloxane having no aminoalkyl group bonded to the silicon atom at either molecular chain end is used.

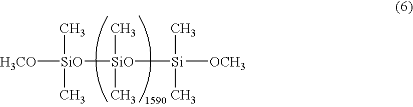

### Comparative Example 2

A 1000-ml glass beaker was charged with 400 g of an organopolysiloxane of formula (7) having a viscosity of 7,500 mm²/s and 20 g of vinyltrimethoxysilane, which were agitated by a homomixer for 5 minutes. Then, 20 g of polyoxyethylene decyl ether (moles of ethylene oxide added=4), 20 g of polyoxyethylene decyl ether (moles of ethylene oxide added=40), and 36 g of water were added. The mixture was agitated by the homomixer, during which a buildup of viscosity was observed. Using a dispersion mixer, it was milled and agitated for a further 10 minutes. Water, 295 g, was added to the mixture and agitated for dilution by the homomixer. With agitation using an anchor-type paddle, a mixture of 6 g of a mineral spirit solution of 44% zinc 2-ethylhexanoate and 6 g of polyoxyethylene decyl ether (moles of ethylene oxide added=8) was then added. Agitation for one hour yielded a silicone emulsion.

After 48 hours from its preparation, an aliquot from the silicone emulsion was placed in a dish where it was allowed to stand at room temperature for 24 hours, during which time water volatilized off. The residue was liquid, indicating that the silicone had not cured. Separately, the silicone emulsion was brush coated onto a rubber sheet and heat treated at 150° C. for 1 minute. A finger touch test on the coated surface showed that the silicone had not cured.

This example demonstrates that an emulsion is little curable when an organopolysiloxane having no aminoalkyl group bonded to the silicon atom at either molecular chain end is used.

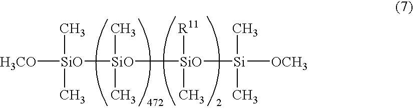

R¹¹ is a group of —C₃H₆NHC₂H₄NH₂.

### Comparative Example 3

A 1000-ml glass beaker was charged with 400 g of the organopolysiloxane of formula (4) having a viscosity of 112,000 mm²/s and 17 g of vinyltrimethoxysilane, which were agitated by a homomixer for 5 minutes. Then, 20 g of polyoxyethylene decyl ether (moles of ethylene oxide added=4), 20 g of polyoxyethylene decyl ether (moles of ethylene oxide added=40), and 36 g of water were added. The mixture was agitated by the homomixer, during which a buildup of viscosity was observed. Using a dispersion mixer, it was milled and agitated for a further 10 minutes. Water, 303 g, was added to the mixture and agitated for dilution by the homomixer. With agitation using an anchor-type paddle, 4 g of a 10% potassium carbonate aqueous solution was then added. Agitation for one hour yielded a silicone emulsion.

After 48 hours from its preparation, an aliquot from the silicone emulsion was placed in a dish where it was allowed to stand at room temperature for 24 hours, during which time water volatilized off, leaving a solid matter. This cured product was found tack-free and elastic on finger touch. Separately, the silicone emulsion was brush coated onto a rubber sheet and heat treated at 150° C. for 1 minute. A finger touch test showed that the coated surface had cured, but remained tacky.

This example demonstrates a slow curing rate when potassium carbonate is used as the catalyst.

### Comparative Example 4

A 1000-ml glass beaker was charged with 400 g of the organopolysiloxane of formula (4) having a viscosity of 112,000 mm²/s and 17 g of vinyltrimethoxysilane, which were agitated by a homomixer for 5 minutes. Then, 20 g of polyoxyethylene decyl ether (moles of ethylene oxide added=4), 20 g of polyoxyethylene decyl ether (moles of ethylene oxide added=40), and 36 g of water were added. The mixture was agitated by the homomixer, during which a buildup of viscosity was observed. Using a dispersion mixer, it was milled and agitated for a further 10 minutes. Water, 295 g, was added to the mixture and agitated for dilution by the homomixer. With agitation using an anchor-type paddle, a mixture of 6 g of a mineral spirit solution of 70% iron 2-ethylhexanoate and 6 g of polyoxyethylene decyl ether (moles of ethylene oxide added=8) was then added. Agitation for one hour yielded a silicone emulsion.

After 48 hours from its preparation, an aliquot from the silicone emulsion was placed in a dish where it was allowed to stand at room temperature for 24 hours, during which time water volatilized off, leaving a solid matter. This cured product was found tack-free and elastic on finger touch. Separately, the silicone emulsion was brush coated onto a rubber sheet and heat treated at 150° C. for 1 minute. A finger touch test showed that the coated surface had cured, but remained tacky.

This example demonstrates a slow curing rate when iron 2-ethylhexanoate is used as the catalyst.

Japanese Patent Application No. 2006-050499 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A film-forming silicone emulsion composition comprising
(A) a diorganopolysiloxane having the general formula (1): 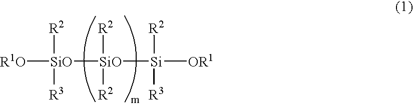
wherein R¹ is each independently hydrogen or a monovalent hydrocarbon group of 1 to 6 carbon atoms, R² is each independently a monovalent hydrocarbon group of 1 to 20 carbon atoms, R³ is a group of the general formula (2): 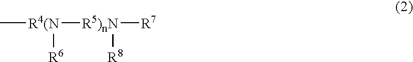
wherein R⁴ is a substituted or unsubstituted divalent hydrocarbon group of 1 to 6 carbon atoms, R⁵ is a divalent hydrocarbon group of 1 to 4 carbon atoms, R⁶, R⁷ and R⁸ are each independently hydrogen or a substituted or unsubstituted monovalent hydrocarbon group of 1 to 10 carbon atoms, n is an integer of 0 to 6, with the proviso that at least one of R⁶, R⁷ and R⁸ is hydrogen when n is not equal to 0, and at least one of R⁷ and R⁸ is hydrogen when n is equal to 0, and m is an integer from 200 to 2,000,
(B) an alkoxysilane having the general formula (3):
R⁹ₐSi(OR¹⁰)₄₋ₐ (3)
wherein R⁹ is a substituted or unsubstituted monovalent hydrocarbon group of 1 to 20 carbon atoms, R¹⁰ is each independently a monovalent hydrocarbon group of 1 to 6 carbon atoms, and “a” is equal to 0 or 1, and/or a partial hydrolytic condensate thereof,
(C) 0.01 to 5 parts by weight per 100 parts by weight of components (A) and (B) combined of a zinc compound, and
(D) 0.1 to 30 parts by weight per 100 parts by weight of components (A) and (B) combined of a surfactant.

2. The silicone emulsion composition of claim 1, wherein the alkoxysilane (B) is selected from the group consisting of methyltrimethoxysilane, methyltriethoxysilane, phenyltrimethoxysilane, phenyltriethoxysilane, vinyltrimethoxysilane, vinyltriethoxysilane, 3,3,3-trifluoropropyltrimethoxysilane, 3,3,3-trifluoropropyltriethoxysilane, tetramethoxysilane, and tetraethoxysilane.
